(19) United States
(12) Patent Application Publication
(10) Pub. No.: US 2014/0316577 A1
(43) Pub. Date: Oct. 23, 2014

(54) APPARATUS AND METHOD FOR CONTROLLING FAN

(71) Applicant: Quanta Computer Inc., Taoyuan Shien (TW)

(72) Inventors: Chun-Jie YU, Keelung City (TW); Yu-Hui CHEN, Tao Yuan Shien (TW)

(21) Appl. No.: 13/930,939

(22) Filed: Jun. 28, 2013

(30) Foreign Application Priority Data
Apr. 23, 2013 (TW) 102114324

(51) Int. Cl. G05B 15/02

(52) U.S. Cl. CPC G05B 15/02
USPC 700/275

(57) ABSTRACT

An apparatus and a method for controlling a fan are disclosed. The apparatus comprises a subtractor, a decision unit, and an adjustment unit. The subtractor calculates a rotational speed difference between a current rotational speed and a target rotational speed. The decision unit decides an adjust factor according to the rotational speed difference. The adjustment unit changes a rotational speed control signal from a first control signal to a second control signal according to the adjust factor.

This application claims the benefit of Taiwan application Serial No. 102114324, filed Apr. 23, 2013, the subject matter of which is incorporated herein by reference.

### BACKGROUND OF THE INVENTION

1. Field of the Invention

The invention relates in general to an electronic apparatus, and more particularly to an apparatus and a method for controlling a fan.

2. Description of the Related Art

Referring to FIG. 1, a relation curve of operation control signal and system temperature of conventional fan rotational speed control is shown. The conventional method for controlling a fan rotational speed outputs operation control signals to achieve different rotational speeds. The level or intensity of the control signal is based on system temperature. The control signal can be divided into digital to analog (DAC) signal type and pulse width modulation (PWM) type to fit the type of the fan. The conventional fan converter normally adjusts the rotational speed in a stepping manner. The micro-processor directly outputs a DAC/PWM operation control signal to drive the fan.

As the design of notebook computer or Tablet PC is directed towards thinness and lightweight, the disposition of internal elements is very compact due to limited space. However, if the fan and the microphone are too close to each other, the microphone may record the noises generated when the fan switches its rotational speed. This is because the fan uses an electromechanical element, and the switching of rotational speed will result in high slope acceleration and generate severe noises and vibrations despite the output signal of the micro-processor having reached the target rotational speed. For example, when temperature abruptly changes at system temperature t1, t2, t3, t4 and t5, the conventional operation control signal will cause the fan to generate noises and vibrations during the switching of rotational speed.

### SUMMARY OF THE INVENTION

The invention is directed to an apparatus and a method for controlling a fan.

According to one embodiment of the present invention, a fan control apparatus is disclosed. The apparatus comprises a subtractor, a decision unit, and an adjustment unit. The subtractor calculates a rotational speed difference between a current rotational speed and a target rotational speed. The decision unit decides an adjust factor according to the rotational speed difference. The adjustment unit changes a rotational speed control signal from a first control signal to a second control signal according to the adjust factor.

According to another embodiment of the present invention, a fan control method is disclosed. The fan control method comprises: calculating a rotational speed difference between a current rotational speed and a target rotational speed; deciding an adjust factor according to rotational speed difference; and changing a rotational speed control signal from a first control signal to a second control signal according to the adjust factor.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a relation curve of operation control signal and system temperature of conventional fan rotational speed control.

FIG. 2 shows a schematic diagram of a fan control apparatus and a fan according to a first embodiment.

FIG. 3 shows a flowchart of a fan control method according to a first embodiment.

FIG. 4 shows a schematic diagram of the first adjustment unit.

FIG. 5 shows a schematic diagram of a second adjustment unit.

FIG. 6 shows a schematic diagram of a third adjustment unit.

FIG. 7 shows a relation curve of operation control signal and system temperature according to a first embodiment.

FIG. 8 shows a schematic diagram of a fan control apparatus and a fan according to a second embodiment.

### DETAILED DESCRIPTION OF THE INVENTION

### First Embodiment

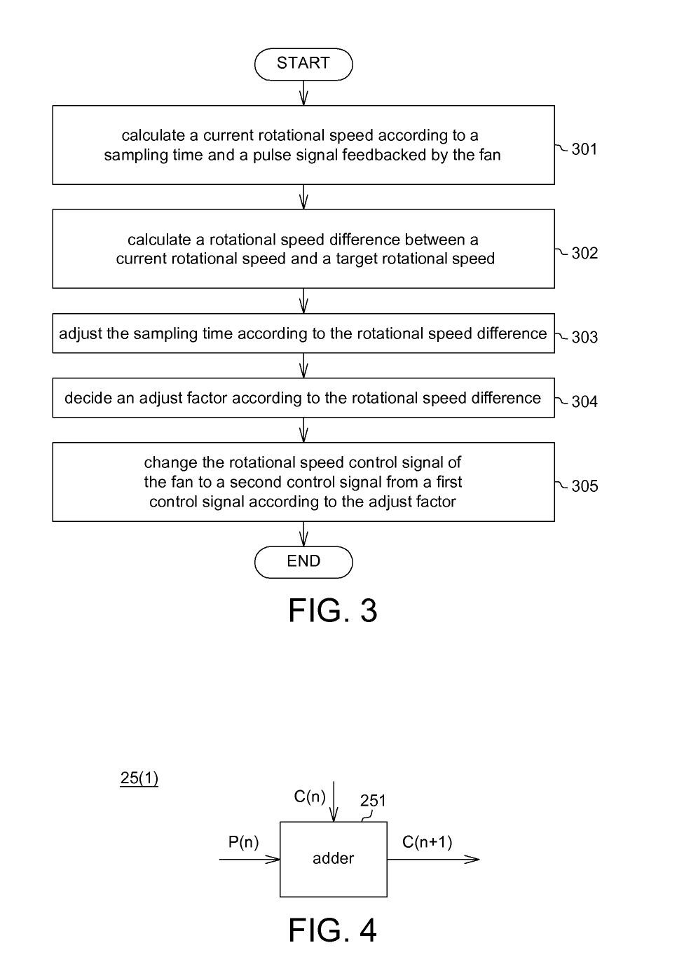

Referring to Table 1, FIG. 2 and FIG. 3. FIG. 2 shows a schematic diagram of a fan control apparatus and a fan according to a first embodiment. FIG. 3 shows a flowchart of a fan control method according to a first embodiment. The fan control apparatus 2 can be used in notebook computer or Tablet PC. The fan control apparatus 2, which controls a fan 1, can be realized by such as an embedded controller (EC). The fan control apparatus 2 comprises a rotational speed calculation unit 21, a subtractor 22, a selector 23, a decision unit 24 and an adjustment unit 25. The rotational speed calculation unit 21, the subtractor 22, the selector 23, the decision unit 24 and the adjustment unit 25 can all be realized by micro-processors. The fan control method can be used in the fan control apparatus 2, and comprises following steps:

Firstly, the method begins at step 301, the rotational speed calculation unit 21 calculates a current rotational speed VC according to a sampling time TS and a pulse signal S1 feedbacked by the fan 1. The rotational speed calculation unit 21 can obtain the current rotational speed VC of the fan 1 according to the sampling time TS and the number of pulses of the pulse signal S1. Next, the method proceeds to step 302, the subtractor 22 calculates a rotational speed difference DV between a current rotational speed VC and a target rotational speed VT. The rotational speed difference DV is equal to the target rotational speed VT deducted by the current rotational speed VC. Then, the method proceeds to step 303, the selector 23 adjusts the next sampling time TS according to the rotational speed difference DV. Once the sampling time changes, corresponding acceleration within a fixed time will change accordingly and the acceleration can thus be changed.

Since the sampling time TS is positively proportional to the rotational speed difference DV, the larger the rotational speed difference DV is, the longer the sampling time TS selected by the selector 23 will be; the smaller rotational speed difference DV is, the shorter the sampling time TS selected by the selector 23 will be. Since the sampling time TS is positively proportional to the acceleration, the acceleration will increase as the sampling time TS increases, and the acceleration will decrease as the sampling time TS decreases. For example, if the rotational speed difference DV is ±1000 rpm, then the sampling time TS and the acceleration are 200 ms and 2× respectively. If the rotational speed difference DV is ±500 rpm, then the sampling time TS and the acceleration are 100 ms and 1× respectively. If the rotational speed difference DV is ±100 rpm, then the sampling time TS and the acceleration are 50 ms and

$$\frac{1}{2} x$$

respectively.

TABLE 1

| Rotational | | | | |
|---|---|---|---|---|
| Speed | | | | |
| Difference | Sampling | | Tolerable | |
| (rpm) | Time (ms) | Acceleration | Error (rpm) | Adjust Factor |
| ≧+1000 | 200 | 2x | ±100 | −1 |
| <−1000 | 200 | 2x | ±100 | +1 |
| ≧+500 | 100 | 1x | ±100 | −1 |
| <−500 | 100 | 1x | ±100 | +1 |
| ≧+100 | 50 | $\frac{1}{2} x$ | ±100 | 0 |
| <−100 | 50 | $\frac{1}{2} x$ | ±100 | 0 |

Then, the method proceeds to step 304, the decision unit 24 decides an adjust factor P(n) according to the rotational speed difference DV. If the rotational speed difference DV is equal to rotational speed permissible error TE, then the decision unit 24 decides the adjust factor as 0. If the rotational speed difference DV is greater than a rotational speed permissible error TE, then the decision unit 24 decides the adjust factor P(n) as a positive value +P. If the rotational speed difference DV is smaller than the rotational speed permissible error TE, then the decision unit 24 decides the adjust factor as a negative value −P. For example, if the rotational speed permissible error TE is ±100 rpm and the rotational speed difference DV is greater than is equal to 1000 rpm, then the decision unit 24 decides the adjust factor P(n) as −1. If the rotational speed permissible error TE is ±100 rpm and the rotational speed difference DV is smaller than −1000 rpm, then the decision unit 24 decides the adjust factor P(n) as +1. If the rotational speed permissible error TE is ±100 rpm and the rotational speed difference DV is greater than is equal to 100 rpm, then the decision unit 24 decides an adjust factor P(n) as 0. After that, the method proceeds to step 305, the adjustment unit 25 changes the rotational speed control signal SC of the fan 1 to a second control signal from a first control signal according to the adjust factor P(n).

Referring to FIG. 2 and FIG. 4. FIG. 4 shows a schematic diagram of the first adjustment unit. The adjustment unit 25 can have different implementations. As indicated in FIG. 4, the adjustment unit 25 is exemplified by an adjustment unit 25(1). The adjustment unit 25(1) comprises an adder 251. The fan 1 receives the first control signal C(n) to achieve the current rotational speed VC. The adder 251 adds the adjust factor P(n) to the first control signal C(n), originally used for driving the fan 1, to generate the first adjustment signal C(n+1), and further uses the first adjustment signal C(n+1) as the second control signal for driving the fan 1.

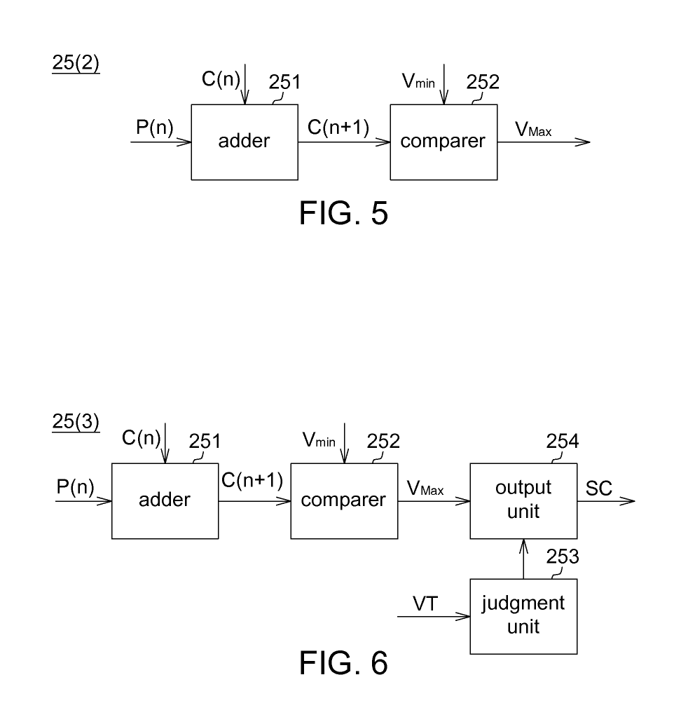

Referring to FIG. 2, and FIG. 5. FIG. 5 shows a schematic diagram of a second adjustment unit. As indicated in FIG. 5, the adjustment unit 25 is exemplified by the adjustment unit 25(2). The adjustment unit 25(2) comprises an adder 251 and a comparer 252. If the rotational speed control signal SC of the fan 1 is the first control signal C(n), then the fan 1 reaches the current rotational speed VC. The adder 251 adds the adjust factor P(n) to the first control signal C(n), originally used for driving the fan 1, to generate the first adjustment signal C(n+1). The comparer 252 selects the maximum of the first adjustment signal C(n+1) and the minimum fan control signal Vmin as a second adjustment signal Vmax, and uses the second adjustment signal Vmax as the second control signal. It should be noted that not all rotational speed control signal SC can make the fan 1 operate. The minimum fan control signal Vmin refers to the minimum rotational speed control signal of all rotational speed control signals SC capable of making the fan 1 operate. Through the selection of the comparer 252, the fan 1 can quickly get out of its dead zone.

Referring to FIG. 2, and FIG. 6. FIG. 6 shows a schematic diagram of a third adjustment unit. As indicated in FIG. 6, the adjustment unit 25 is exemplified by the adjustment unit 25(3). The adjustment unit 25(3) comprises an adder 251, a comparer 252, a judgment unit 253 and an output unit 254. The fan 1 receives a first control signal C(n) to achieve a current rotational speed VC. The adder 251 adds the adjust factor P(n) to the first control signal C(n), originally used for driving the fan 1, to generate the first adjustment signal C(n+1). The comparer 252 selects the maximum of the first adjustment signal C(n+1) and the minimum fan control signal Vmin as a second second adjustment signal Vmax. The judgment unit 253 judges whether the target rotational speed VT is greater than 0. If the target rotational speed VT is greater than 0, then the output unit 254 outputs the second adjustment signal Vmax as a second control signal. If the target rotational speed is equal to 0, then the output unit 254 stops outputting the second adjustment signal Vmax as the second control signal.

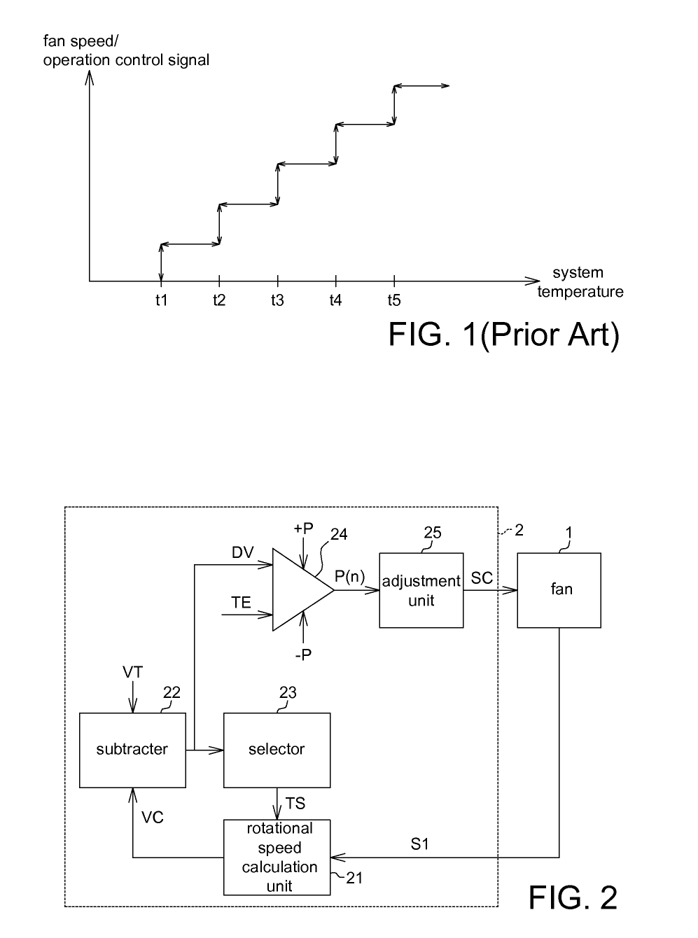

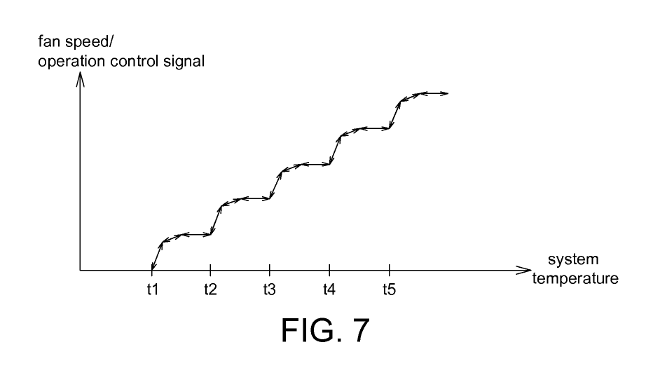

Referring to FIG. 1 and FIG. 7. FIG. 7 shows a relation curve of operation control signal and system temperature according to a first embodiment. It can be clearly seen from FIG. 1 that the fan rotational speed is adjusted with high acceleration according to the stepping rotational speed control of the prior art. It can be clearly seen from FIG. 7 that in the first embodiment, several mild acceleration segments are added to mitigate the noises and vibrations caused by high acceleration of the fan. For example, in the present embodiment, the operation control signal does not change abruptly when system temperature is t1, t2, t3, t4 or t5, such that the noises and vibrations generated during the switching of rotational speed can thus be reduced.

### Second Embodiment

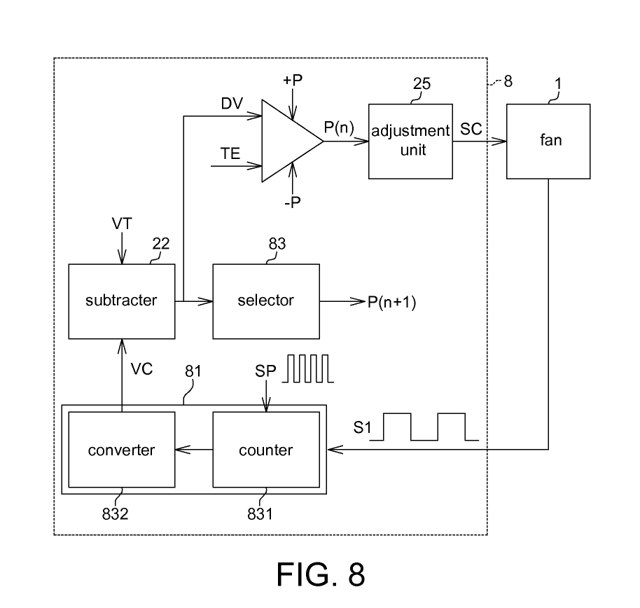

Referring to Table 2 and FIG. 8. FIG. 8 shows a schematic diagram of a fan control apparatus and a fan according to a second embodiment. The second embodiment is different the first embodiment mainly in that the rotational speed calculation unit 81 and the selector 83 of the second embodiment replaces the rotational speed calculation unit 21 and the selector 23 of the first embodiment respectively. Furthermore, the selector 83 comprises a counter 831 and a converter 832. The counter 831 counts the number of pulses of the pulse signal S1 feedbacked by the fan 1 and conformed to the sampling pulse S. The sampling pulse SP refers to the high speed sampling pulse of the micro-processor. The sampling frequency of the high speed sampling pulse is such as 25 MHz. The converter 832 further converts the number of pulses to the current rotational speed VC.

The selector 83 adjusts the next adjust factor P(n+1) according to the rotational speed difference DV. The second embodiment can further select the magnitude of the positive value +P or the negative value −P according to rotational speed difference DV. For example, if the rotational speed difference DV is greater than is equal to 1000 rpm, then the selector 83 selects −2 as the next adjust factor P(n+1) to perform a larger scale of adjustment. If the rotational speed difference DV is greater than is equal to 500 rpm, then the selector 83 selects −1 as the next adjust factor P(n+1) to perform a smaller scale of adjustment. If the rotational speed difference DV is greater than is equal to 100 rpm, then the selector 83 selects 0 as the next adjust factor P(n+1) to stop adjustment.

TABLE 2

| Rotational Speed | Sampling | Tolerable | |
|---|---|---|---|
| Difference | Frequency | Error | Adjust |
| (rpm) | (MHz) | (rpm) | Factor |
| ≧+1000 | 25 | ±100 | −2 |
| <−1000 | 25 | ±100 | +2 |
| ≧+500 | 25 | ±100 | −1 |
| <−500 | 25 | ±100 | +1 |
| ≧+100 | 25 | ±100 | 0 |
| <−100 | 25 | ±100 | 0 |

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fan control method, comprising:
calculating a rotational speed difference between a current rotational speed and a target rotational speed;
deciding an adjust factor according to the rotational speed difference; and
changing a rotational speed control signal of the fan from a first control signal to a second control signal according to the adjust factor.

2. The fan control method according to claim 1, wherein in the step of deciding the adjust factor, the adjust factor is 0 if the rotational speed difference is equal to a rotational speed permissible error.

3. The fan control method according to claim 1, wherein in the step of deciding the adjust factor, the adjust factor is a positive value if the rotational speed difference is greater than a rotational speed permissible error.

4. The fan control method according to claim 1, wherein in the step of deciding the adjust factor, the adjust factor is a negative value if the rotational speed difference is smaller than a rotational speed permissible error.

5. The fan control method according to claim 1, wherein the changing step comprises:
adding the adjust factor to the first control signal to generate a first adjustment signal; and
using the first adjustment signal as the second control signal.

6. The fan control method according to claim 1, wherein the changing step comprises:
adding the adjust factor to the first control signal to generate a first adjustment signal;
selecting the maximum of the first adjustment signal and a minimum fan control signal as a second adjustment signal; and
using the second adjustment signal as the second control signal.

7. The fan control method according to claim 1, wherein the changing step comprises:
adding the adjust factor to the first control signal to generate a first adjustment signal;
selecting the maximum of the first adjustment signal and a minimum fan control signal as a second adjustment signal;
judging whether the target rotational speed is greater than 0; and
outputting the second adjustment signal as the second control signal if the target rotational speed is greater than 0.

8. The fan control method according to claim 7, wherein the changing step comprises:
stopping outputting the second adjustment signal as the second control signal if the target rotational speed is equal to 0.

9. The fan control method according to claim 1, further comprising:
calculating the current rotational speed according to a sampling time and a pulse signal feedbacked by the fan.

10. The fan control method according to claim 9, further comprising:
adjusting a sampling time according to the rotational speed difference.

11. The fan control method according to claim 1, further comprising:
counting the number of pulses of a pulse signal feedbacked by the fan and conformed to a sampling pulse; and
converting the number of pulses to the current rotational speed.

12. The fan control method according to claim 11, further comprising:
adjusting the adjust factor according to the rotational speed difference.

13. A fan control apparatus, comprising:
a subtractor used for calculating a rotational speed difference between a current rotational speed and a target rotational speed;
a decision unit used for deciding an adjust factor according to the rotational speed difference; and
an adjustment unit used for changing a rotational speed control signal of the fan to a second control signal from a first control signal according to the adjust factor.

14. The fan control apparatus according to claim 13, wherein the decision unit decides the adjust factor as 0 if the rotational speed difference is equal to a rotational speed permissible error.

15. The fan control apparatus according to claim 13, wherein the decision unit decides the adjust factor as a positive value if the rotational speed difference is greater than a rotational speed permissible error.

16. The fan control apparatus according to claim 13, wherein the decision unit decides the adjust factor as a negative value if the rotational speed difference is smaller than a rotational speed permissible error.

17. The fan control apparatus according to claim 13, wherein the adjustment unit comprises:
an adder used for adding the adjust factor to the first control signal to generate a first adjustment signal and using the first adjustment signal as the second control signal.

18. The fan control apparatus according to claim 13, wherein the adjustment unit comprises:
an adder used for adding the adjust factor to the first control signal to generate a first adjustment signal; and
a comparer used for selecting the maximum of the first adjustment signal and a minimum fan control signal as a second adjustment signal and using the second adjustment signal as the second control signal.

19. The fan control apparatus according to claim 13, wherein the adjustment unit comprises:
an adder used for adding the adjust factor to the first control signal to generate a first adjustment signal;
a comparer used for selecting the maximum of the first adjustment signal and a minimum fan control signal as a second adjustment signal;
a judgment unit used for judging whether the target rotational speed is greater than 0; and
an output unit used for outputting the second adjustment signal as the second control signal if the target rotational speed is greater than 0.

20. The fan control apparatus according to claim 19, wherein the output unit stops outputting the second adjustment signal as the second control signal if the target rotational speed is equal to 0.

21. The fan control apparatus according to claim 13, further comprising:
a rotational speed calculation unit used for calculating the current rotational speed according to a sampling time and a pulse signal feedbacked by the fan.

22. The fan control apparatus according to claim 21, further comprising:
a selector used for adjusting a sampling time according to the rotational speed difference.

23. The fan control apparatus according to claim 13, wherein the rotational speed calculation unit comprises:
a counter used for counting the number of pulses of a pulse signal feedbacked by the fan and conformed to a sampling pulse; and
a converter used for converting the number of pulses to the current rotational speed.

24. The fan control apparatus according to claim 23, further comprising:
a selector used for adjusting the adjust factor according to the rotational speed difference.
